(19) United States
(12) Patent Application Publication
(10) Pub. No.: US 2006/0078289 A1
(43) Pub. Date: Apr. 13, 2006

(54) System and Related Method for Video Data Processing

(76) Inventors: Wu-Hsien Chung, Tainan County (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,951

(22) Filed: Sep. 29, 2005

(30) Foreign Application Priority Data
Sep. 30, 2004 (TW) 093129650

(51) Int. Cl. H04N 5/76; G11B 27/00

(52) U.S. Cl. 386/52; 386/131

(57) ABSTRACT

A system for video data processing includes an media processing device for converting data stored in a storage media into digital data, a digital media recorder board for converting the digital data into a first type signal, a computer for converting the digital data into a second type signal, and a controller for inputting the digital data selectively to the computer or the digital media recorder board. A method for controlling the system for video data processing includes selecting either the digital media recorder board or the computer. When the digital media recorder is selected, the controller connects to the digital media recorder board and accesses the media processing device. When the computer is selected, the controller connects to the digital media recorder board and accesses the media processing device.

### BACKGROUND OF THE INVENTION

1. Field of the Invention

The present invention relates to a system and related method for video data processing system, more particularly, to a system and related method for video data processing system in utilizing a controller to integrate a digital media recorder board and a computer.

2. Description of the Prior Art

Digital video disc player (a.k.a., DVD player) is a common electric appliance that can be found in most homes. Another common electric apparatus is a personal computer. Most all personal computers are equipped with a digital video disc access device. The former is usually known as a stand-alone DVD player.

Please refer to FIG. 1. FIG. 1 illustrates a diagram of a conventional video data processing system 100. Video data processing system 100 comprises: a television set 110, a stand-alone DVD player 120, and a television signal cable 130 coupled to and located in between the television set 110 and the stand-alone DVD player 120. The stand-alone DVD player 120 further comprises a digital media player device 122 and a media processing device 124 for reading video data on a compact disc that has been loaded in the media processing device 124 (not shown in FIG. 1) and for converting into digital data groupings of 0's and 1's. The conversion is performed by the digital media player board 22. The digital media player board 22 converts the digital data transmitted from the media processing device 124 into a television-formatted data. The television-formatted data is then outputted for broadcast to the television set 110 via the television signal cable 130. Please refer to FIG. 2. FIG. 2 illustrates a diagram of a video data processing system 200 integrated by a computer equipped with a CD-ROM 210; it is a computer screen for displaying computer format data. A computer mainframe 220, as shown in FIG. 2, comprises a motherboard 222 and an media processing device 224 for accessing data on a compact disc. The computer mainframe 220 transmits the data for broadcast to the computer screen 210 via the computer signal cable 230. Similar in function to the media processing device 124 in FIG. 1, the media processing device 224 of FIG. 2 also reads the video data on the compact disc and converts it into digital data. The motherboard 222 then converts the digital data transmitted from the media processing device 224 into computer format data. The computer format data is then transmitted for broadcast to the computer screen 210 via the computer signal cable 230.

The digital video disc access device, as equipped in the computer, is able to broadcast the video data stored on the compact disc and, if there is a writing function installed, write video data into the compact disc. As shown in FIG. 2, after converting computer format data into digital write data, the motherboard 222 transmits the digital write data to the media processing device 224 for accessing data on the compact disc. The media processing device 224 will then write video data corresponding to the digital write data into a compact disc. A common method for a user to utilize the digital video disc access device to write the image data is to utilize an external TV capture card. When a user utilizes the digital video disc access device to write the image data broadcasted on the television, the external TV capture card will convert television format signal into the computer format signal and then transmits the signal to the computer. Next, the motherboard of the above-mentioned method converts the computer format signal into the digital write data. Next, the media processing device 224 writes the digital write data into the compact disc. An advantage of the above-mentioned method is that the computer simultaneously writes data and broadcasts a portion of image data. Additionally, the external TV capture card increases hardware cost for the whole system as well as negatively effecting the quality and speed of recording the image data. The digital media player board 122 of FIG. 1 may also be equipped with a recording function known as a digital media recorder board (DMR board). The DMR board is able to record a television image signal without requiring the computer to capture the television signal. The media processing device 124 of FIG. 1 and the media processing device 224 of FIG. 2 are identical devices equipped for home utilization. The media processing device 124 and the media processing device 224 perform identical functions. Unfortunately, the two devices cannot be utilized at the same time. They must be utilized one at a time, hence this causes a waste in resources.

### SUMMARY OF THE INVENTION

The claimed invention relates to a system and related method for video data processing, more particularly, to a system and related method for video data processing utilizing a controller to combine a digital media recorder board and a computer which allows the digital media recorder board and the computer to share a video signal of an media processing device to overcome the problem mentioned above in the prior art.

One embodiment of the claimed invention is a video data processing system, the system comprising an media processing device for converting video data stored in a storage media into digital data; a digital media recorder board for converting the digital data into a first type signal; a computer for converting the digital data into a second type signal; and a controller, coupled to the media processing device, the computer and the digital media recorder board, for inputting the digital data selectively to the computer or the digital media recorder board.

Another embodiment of the claimed invention is a method of controlling a video data processing system for processing a digital data, the method comprising: selecting either a digital media recorder board or a computer to process the digital data; when the digital media recorder board is selected to process the digital data, a controller is coupled to the digital media recorder board, the digital media recorder board accesses a media processing device via the controller; and when the computer is selected to process the digital data, the controller is coupled to the computer, the computer accesses the media processing device via the controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a conventional video data processing system.

FIG. 2 illustrates a diagram of another conventional video data processing system.

FIG. 3 illustrates a diagram of a video data processing system according to the first embodiment of the present invention.

FIG. 4 illustrates a diagram of a video data processing system according to the second embodiment of the present invention.

FIG. 5 illustrates a flowchart of method of controlling a video data processing system according to the first embodiment of the present invention.

FIG. 6 illustrates a flowchart of method of controlling a video data processing system according to the second embodiment of the present invention.

### DETAILED DESCRIPTION

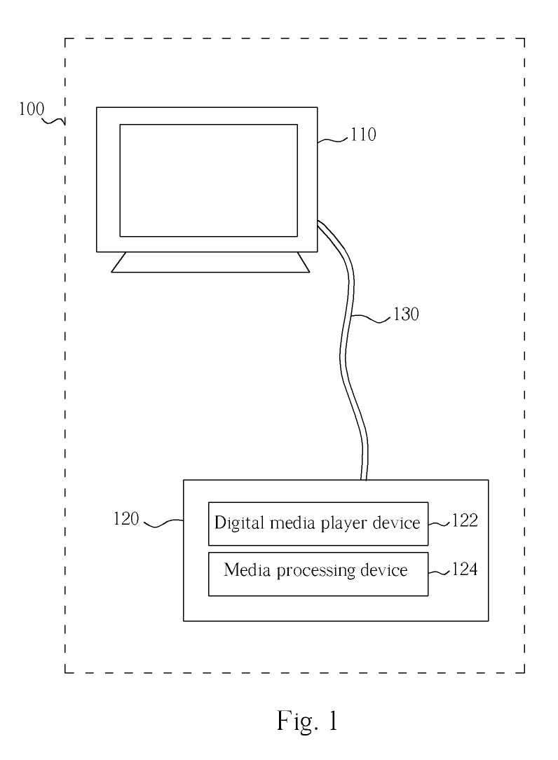

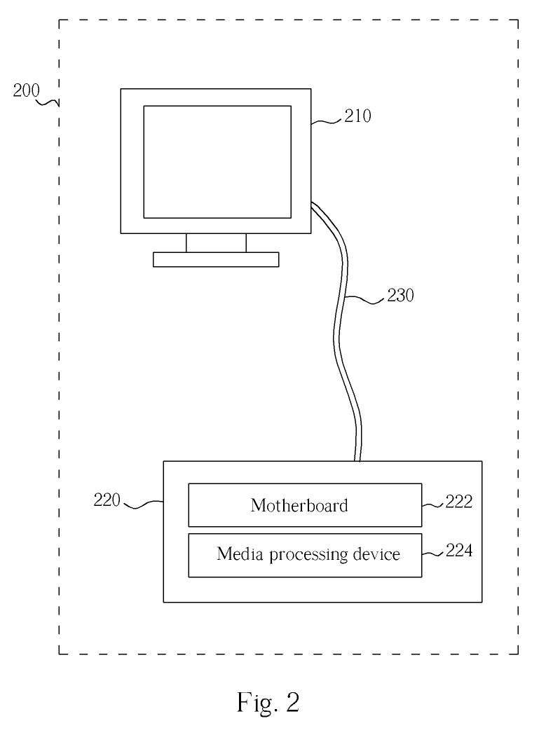

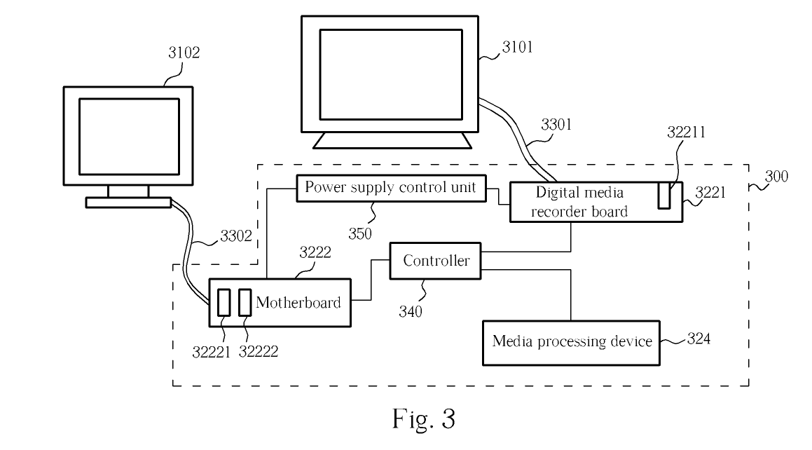

Please refer to FIG. 3. FIG. 3 illustrates a diagram of a video data processing system according to the first embodiment. 3101 can be a television screen, 3102 can be a computer screen; the video data processing system 300 comprises a digital media recorder board 3221, a motherboard 3222 of a computer, a controller 340 and a media processing device 324. The digital media recorder board 3221 is coupled to the television screen 3101 through a television signal cable 3301. The motherboard 3222 is coupled to the computer screen 3102 through a computer signal cable 3302. The function of the digital media recorder board 3221, converting video data of a compact disc into digital data to television-formatted data, is identical to the function of the digital media recorder board 122 of FIG. 1. The converted video data is transmitted to the television screen 3101 for broadcast through the television signal cable 3301. The function of the motherboard 3222, converting video data of a compact disc into digital data to computer format data, is identical to the function of the conventional computer motherboard 222 of FIG. 2. The converted video data is transmitted to the computer screen 3102 for broadcast through the computer signal cable 3302. 340 can be a controller and it is coupled to the digital media recorder board 3221, the motherboard 3222, and an media processing device 324. The function of the media processing device 324 is identical to the function of the two other devices: the conventional media processing device in the standalone DVD player and the media processing device in the digital video disc access device. Through the controller of the present invention, the standalone DVD player and the personal computer equipped with the digital video disc access device can share an media processing device. When the user wants to broadcast video data stored on the compact disc on the television screen 3101, the controller selects to couple to the digital media recorder board 3221 and the media processing device 324; hence the media processing device 324, the digital media recorder board 3221, and the television screen 3101 form a complete sound and visual system. The media processing device converts the video data on the compact disc (not shown in FIG. 3) into the digital data and transmits to the controller 340. The controller 340 then transmits the digital data to the digital media recorder board 3221. The digital media recorder board 3221 then converts the digital data into television format data and outputs it to the television screen 3101 for broadcast via the television signal cable 3301. As shown in FIG. 3, the digital media recorder board 3221 further comprises an external video input port 32211. This port can receive television signal, satellite signal, or cable television signal. That signal may then be broadcast onto the television screen 3101. When the user wishes to broadcast video data onto the computer screen 3102 that has been stored on the compact disc the controller selects to couple the motherboard 3222 and the media processing device 324. This identical process takes place when the user wishes to edit the video data utilizing the computer. Hence, the media processing device 324, the motherboard 3222, and the computer screen 3201 forms a complete sound and visual system. The media processing device converts the video data on the compact disc (not shown in FIG. 3) into the digital data and transmits to the controller 340, the controller 340 then transmits the digital data to the motherboard 3222, the motherboard 3222 then converts the digital data into computer format data. Finally, the motherboard 3222 outputs to the computer screen 3102 via the computer signal cable 3302 or, when the user wants to edit computer format data, the motherboard 3222 converts the digital data into computer format data and outputs to an edit module 32221 of the motherboard 3222 for editing the computer format data.

In the above-mentioned, the video data processing system 300 of the present invention utilizes a controller 340 to allow the standalone DVD player and the digital video disc access device of the computer to share an media processing device 324. As shown in FIG. 3, the video data processing system can also comprise a power supply control unit 350. The power supply control unit 350 is utilized for shutting down the power supply of either the digital media recorder board 3221 or the computer motherboard 3222 should one be not operating (i.e., idle). This action is taken in an effort to reduce power consumption as well as conserve hardware resources.

The video data processing system 300 of the present invention is capable of utilizing the motherboard 3222 to convert computer format data that is stored in the computer, into digital data. The controller 340 then transmits the digital data directly to the digital media recorder board 3221 without being required to utilize the method of the media processing device 324. The digital media recorder board 3221 converts the digital data into television format data and outputs it to the television screen 3101 for broadcast via the television signal cable 3301. The video data processing system 300 is also capable of utilizing the controller 340 to transmit the digital data from the digital media recorder 3221 directly to the motherboard 3222. The motherboard 3222 then converts the digital data into computer format data. Next, the edit module 32221 will edit the computer format data. Additionally, the motherboard 3222 may further comprise an output module 32222. The output module 32222 is utilized for converting the computer format data into digital data and then transmitting it to the controller 340. The controller 340 then transmits the digital data to the digital media recorder board 3221 where it will be converted into television format data and then outputted to the television screen 3101 for broadcast via the television signal cable 3301. The source of the digital data transmitted from the digital media recorder board 3221 can be an external receiving video signal. This increases the convenience to the user in recording and editing the video signal. The media processing device 324 of the video data processing system 300 is capable of reading the data on the compact disc; it is also capable of writing data into the compact disc. After the edited computer format data is converted into digital write data, it is transmitted to the controller 340, which is then transmitted to the media processing device 324 for writing the video signal into the compact disc. Compare this to the prior art of a conventional television sound and visual system and computer that require the media processing device to write data into the compact disc, and then that information on the disc is then utilized by the two systems. Therefore, the present invention is obviously more effective in terms of sequence (i.e., utilization of resources) and due to its simplified structure.

Furthermore, the current digital televisions have an analog signal-receiving end and a digital signal-receiving end equipped for receiving and displaying television format data and computer format data. The digital television can therefore function as a television screen and a computer screen.

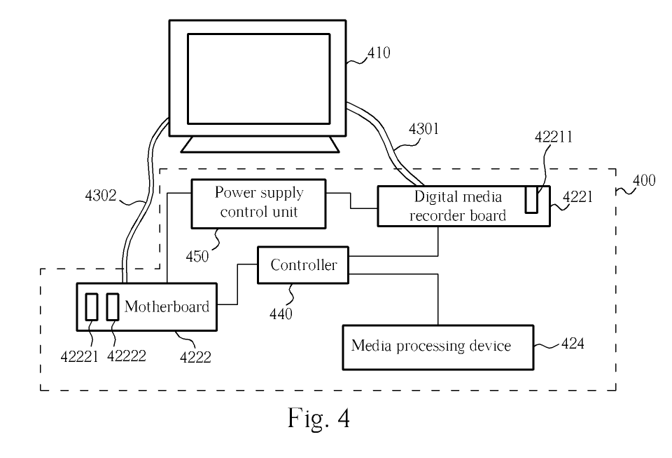

Please refer to FIG. 4. FIG. 4 illustrates a diagram of a video data processing system according to the second embodiment of the present invention. 410 can be a display unit that is able to receive and display television format data and computer format data. The video data processing system 400 comprises a digital media recorder board 4221, a motherboard 4222 of a computer; the motherboard 4222 comprises an edit module 42221 and an output module 42222, the digital media recorder board 4221 comprises an external video input port 42211 and the digital media recorder board 4221 is coupled to the display unit 410 via a television signal cable 4301, and the motherboard 4222 is coupled to the display unit 410 via a computer signal cable 4302. The functions of the devices are similar to the devices of FIG. 3 according the first embodiment: 424 can be a media processing device, 440 can be a controller, 450 can be a power supply control unit; the controller 440 is coupled to the digital media recorder board 4221, the motherboard 4222, and the media processing device 424. The power supply control unit 450 is coupled to the digital media recorder board 4221 and the motherboard 4222 is capable of controlling the power supply. Through the display unit 410, the structure of the video data processing system 400 has become simplified. The present invention realizes power savings as well as reduces hardware resources when a digital television, which has a television system, receives a computer signal at the same time.

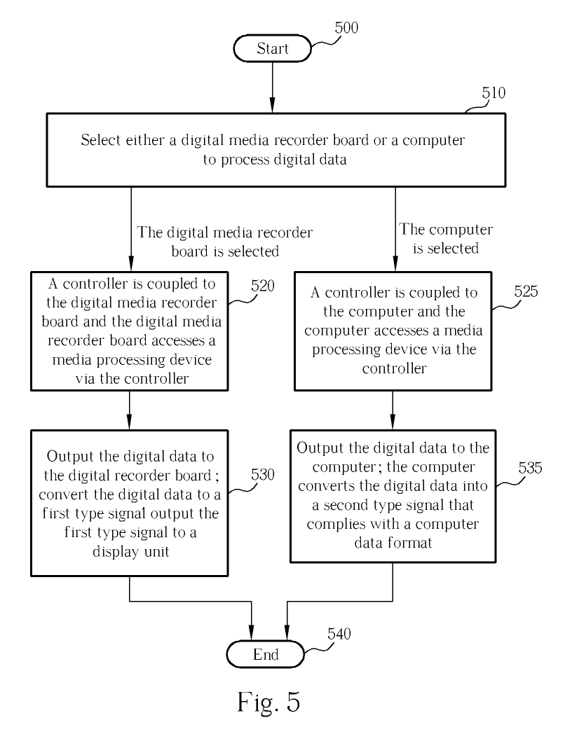

Please refer to FIG. 5. FIG. 5 illustrates a flowchart of a method of controlling a video data processing system according to the first embodiment of the present invention.

Step 500: start;

Step 510: select either a digital media recorder board or a computer to process digital data; execute step 520 when the digital media recorder board is selected to process the digital data; execute step 525 when the computer is selected to process the digital data;

Step 520: a controller is coupled to the digital media recorder board and the digital media recorder board accesses an media processing device via the controller; execute step 530:

Step 525: a controller is coupled to the computer and the computer accesses the media processing device via the controller; execute step 535;

Step 530: output the digital data to the digital recorder board; convert the digital data to a first type signal; output the first type signal to a display unit;

Step 535: output the digital data to the computer; the computer converts the digital data into a second type signal that complies with a computer data format;

Step 540: end.

In the sequence of FIG. 5, if in step 510 either the digital recorder board or the computer is selected to access video data in the storage media (such as a DVD) stored in the media processing device, there is a step 501 before step 510. Step 501 in the sequence is required to convert the video data in the storage media into the digital data. If in step 510, either the digital recorder board or the computer is selected to capture an image data, there is a step 502 before step 510. Step 502 in the sequence is required to convert a first type signal of the digital media recorder board into the digital signal or there is also a step 503 required to convert a second type signal of the digital media recorder board into the digital signal. If in step 510, the computer is selected to access a digital data and the computer is also selected to broadcast the digital data then step 535 will further comprise outputting the second type signal to a display unit. If in step 510, the computer is selected to access a digital data and the computer is also selected to edit the digital data, then step 535 will further comprise editing the second type signal, and the edited second type signal is then converted to digital write data, and then written into the media processing device.

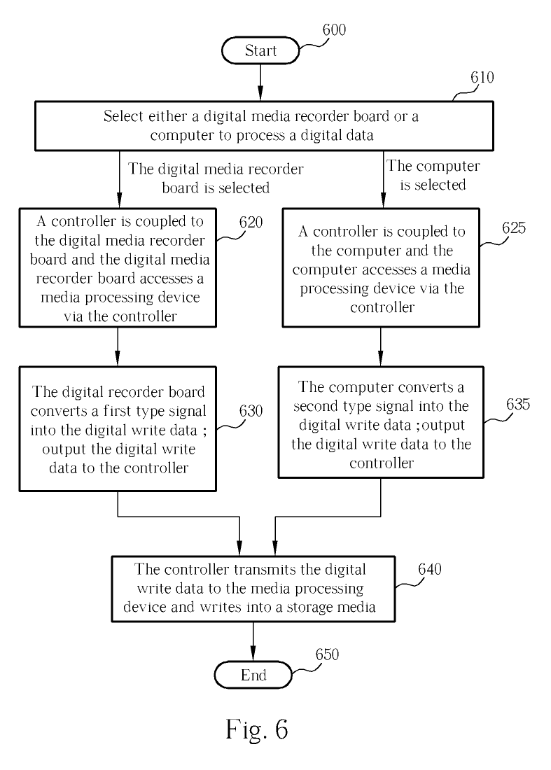

Please refer to FIG. 6. FIG. 6 illustrates a flowchart of a method of controlling a video data processing system according to the second embodiment of the present invention.

Step 600: start;

Step 610: select either a digital media recorder board or a computer to process a digital data; execute step 620 when the digital media recorder board is selected to process the digital data; execute step 625 when the computer is selected to process the digital data;

Step 620: a controller is coupled to the digital media recorder board and the digital media recorder board accesses a media processing device via the controller; execute step 630;

Step 625: a controller is coupled to the computer and the computer accesses the media processing device via the controller; execute step 635;

Step 630: the digital recorder board converts a first type signal into the digital write data; output the digital write data to the controller;

Step 635: the computer converts a second type signal into the digital write data; output the digital write data to the controller;

Step 640: the controller transmits the digital write data to the media processing device and writes into a storage media;

Step 650: end.

In the sequence of FIG. 6 is as follows: after either the computer or the digital media recorder board converts the computer data or the television data into digital write data, the digital write data is then transmitted to the media processing device via the controller and is written into a storage media.

For example, suppose that the video data processing system of the present invention is equipped with function of power saving as mentioned above. Note that in the sequence of FIG. 5 and FIG. 6 and specifically in step 510 and step 610 power savings is realized. When either the digital media recorder board or the computer is selected to process the digital data, the power supply of the other will be shut off.

In conclusion to the above-mentioned, the present invention utilizes a controller to combine individual operation of the television system and the computer system such that the standalone DVD player of the television screen and the compact disc player equipped in the computer can share a media processing device; in method of controlling the power supply, it reduces power consumption as well as hardware resources. In the shared media processing device of the video data processing system, when the user wants to record or edit the image data broadcasted by the television, the image data of the television is converted into digital signal and is transmitted to the computer directly. The digital signal is then converted to computer signal to be edited by the edit module of the computer, and after editing, the image data is converted back to digital data through the output module of the computer motherboard to be written into the storage media in the media processing device. The media processing device of the video data processing system is able to access storage media such as the previously mentioned DVD and video compact disc (VCD) or other types of storage media for storing video images and data. This system is applicable if the computer motherboard and the digital media recorder board are equipped with related access function.

The present invention comprises a system and method for video data processing in utilizing a controller and method of sharing a media processing device. The present invention simplifies and improves on hardware structure and operation sequence of the prior art video data processing system; and in coordinating with method of controlling power supply; the present invention can further reduce power consumption as well as hardware resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video data processing system, the system comprising:
a media processing device for converting data stored in a storage media into digital data;
a digital media recorder board for converting the digital data into a first type signal;
a computer for converting the digital data into a second type signal; and
a controller, coupled to the media processing device, the computer, and the digital media recorder board, for selectively inputting the digital data to the computer and the digital media recorder board.

2. The system of claim 1 wherein the computer and the digital media recorder board are coupled to an output device for receiving the first type signal and the second type signal, and the output device for displaying the received signals.

3. The system of claim 1 further comprising:
a power supply control unit for selectively providing power supply to the computer and the digital media recorder, when the media processing device outputs the digital data to the computer, the power supply control unit shuts down the power supply of the digital media recorder board, and when the media processing device outputs the digital data to the digital media recorder board, the power supply control unit shuts down the power supply of the computer.

4. The system of claim 1 wherein the media processing device further writes a digital write data transmitted from the controller into a storage media.

5. The system of claim 4 wherein the computer converts a second type signal to a digital write data and outputs the digital write data to the controller, the controller then transmits the digital write data to the media processing device.

6. The system of claim 5, the computer further comprising:
an edit module for editing a second type signal; and
an output module for converting the edited second signal to the digital write data and outputting the digital write data.

7. The system of claim 4 wherein the digital media recorder board converts a first type signal to a digital write data and outputs the digital write data to the controller, the controller then transmits the digital write data to the media processing device.

8. The system of claim 1 wherein the media processing device is an optical disc drive (ODD) and the storage media is a compact disc.

9. The system of claim 1 wherein the first type of signal is an analog signal.

10. A method of controlling a video data processing system for processing a digital data, the video data processing system comprising a media processing device, a digital media recorder board, a computer and a controller each coupled to the media processing device, the method comprising the following steps:
(a) selecting one of the digital media recorder board and the computer to process the digital data;
(b) processing the digital data utilizing the digital media recorder boards, coupled to the controller, by accessing the media processing device through the controller when the digital media recorder board is selected; and
(c) the computer accessing the media processing device through the media processing device when the computer, coupled to the controller, is selected to process the digital data.

11. The method of claim 10 further comprising:
converting a video signal of the storage media into the digital data.

12. The method of claim 11 wherein step (c) further comprises:
outputting the digital data to the computer; and
the computer converting the digital data into a second type signal complying to the computer data format.

13. The method of claim 12 wherein the method further comprises:
editing the second type signal into a digital write data;
outputting the digital write data to the media processing device; and
storing the digital write data into the media processing device.

14. The method of claim 11 wherein the video data processing system, coupled to a display device, and step (b) further comprises:
inputting the digital data to the digital media recorder board;
converting the digital data into a first type signal; and
outputting the first type signal to the display device.

15. The method of claim 10 further comprising:
converting a second type signal of the computer into the digital data.

16. The method of claim 15 wherein the digital data is a digital write data and step (c) further comprises:
the computer outputting the digital write data into the controller; and
the controller writing the digital write data into the storage media.

17. The method of claim 15 further comprising:
outputting the digital data to the digital media recorder board; and
the digital media recorder board converting the digital data into a first type signal.

18. The method of claim 10 wherein the method further comprises:
the digital media recorder board converting a first type signal into the digital data.

19. The method of claim 18 wherein the digital data is a digital write data and step (b) further comprises:
the digital media recorder board outputting the digital write data into the controller and the controller writing the digital write data into the storage media.

20. The method of claim 18 wherein step (c) further comprises:
outputting the digital data to the computer;
the computer editing the digital data to a first type signal; and
outputting and storing the first type signal into the media processing device.

21. The method of claim 10 wherein step (b) further comprises:
shutting down the power supply of the computer.

22. The method of claim 10 wherein step (c) further comprises:
shutting down the power supply of the digital media recorder board.

23. The method of claim 10 wherein the video data processing system further comprises an external image input port and the digital data derives from the external image input port.
